(19) United States
(12) Patent Application Publication
(10) Pub. No.: US 2018/0005235 A1
(43) Pub. Date: Jan. 4, 2018

(54) ELECTRONIC TRANSACTION RISK ASSESSMENT BASED ON DIGITAL IDENTIFIER TRUST EVALUATION

(71) Applicant: CA, Inc., New York, NY (US)

(72) Inventor: Jay William Thorne, Port Coquitlam (CA)

(21) Appl. No.: 15/196,984

(22) Filed: Jun. 29, 2016

(51) Int. Cl. G06Q 20/40; H04L 9/32; G06Q 20/38; H04L 29/06

(52) U.S. Cl. CPC G06Q 20/409; H04L 63/08; H04L 9/3242; H04L 63/168; G06Q 20/382; H04L 9/3265; H04L 9/3247; H04L 2209/38; H04L 2209/56

(57) ABSTRACT

For a comprehensive view of the parties involved in a transaction, a transaction risk assessment system can collect and persist digital credentials of entities' involved in a requested electronic transaction. With the entity credentials, the transaction risk assessment system performs an on-demand risk analysis of the requested electronic transaction based, at least in part, on previously collected historical transaction data of the entities involved in the electronic transaction. The risk assessment system searches the historical transaction data for information about the entities involved in the requested transaction and evaluates discovered information. The transaction risk assessment system can quantify trustworthiness of each entity involved in the requested transaction based on the evaluation of the discovered information. The transaction risk assessment system can then quantify risk of executing the transaction at least using the quantified trustworthiness of the involved entities.

### BACKGROUND

The disclosure generally relates to the field of digital security, and more particularly to electronic transaction risk evaluation with digital identifiers.

Public Key Infrastructure (PKI) allows for automated identification and authentication through the use of digital certificates. A digital certificate is structured data that can be used to authenticate an identity of an individual, institution, and/or device. A digital certificate can be considered a digital credential, although it can also be used to secure data and electronically sign an electronic document. A digital certificate typically includes information that identifies the entity that owns the digital certificate (owner), the owner's public key, a key algorithm, a serial number of the digital certificate, an identity of an issuing entity or Certificate Authority, and the digital signature of the issuing entity. A Certificate Authority (CA) issues digital certificates and digitally signs the issued digital certificates with the CA's private key to guarantee validity of the issued certificates. By issuing a signed digital certificate for an entity, the CA guarantees the validity of the digital certificate for a period of time. Thus, an identity is authenticated with a digital certificate and the authentication can be trusted based on the guaranteed validity by the CA.

Often, an entity's digital certificate is associated with at least one other digital certificate. Together, the digital certificates form a certificate chain based on a hierarchy of trust. The certificate chain, in the case of a two tier hierarchy of trust, includes the owner's digital certificate, the issuing entity's digital certificate, and the digital certificate of the root CA that issued the issuing entity's digital certificate. Thus, the root CA guarantees validity of the issuing entity's digital certificate and the issuing entity guarantees validity of the owner's identity.

### BRIEF DESCRIPTION OF THE DRAWINGS

Aspects of the disclosure may be better understood by referencing the accompanying drawings.

FIG. 1 depicts a conceptual example of a transactional history based transaction risk assessment system.

FIG. 2 depicts a flow diagram of example operations for assessing the risk of executing a transaction request.

FIG. 3 depicts a flow diagram of example operations for assessing the risk of executing a transaction request using a rules-based technique.

FIG. 4 depicts an example computer system with an electronic transaction risk assessment based on digital identifier trust evaluation system.

### DESCRIPTION

The description that follows includes example systems, methods, techniques, and program flows that embody aspects of the disclosure. However, it is understood that this disclosure may be practiced without these specific details. For instance, this disclosure refers to financial transactions in illustrative examples. But aspects of this disclosure can be applied to other types of transactions, such as commercial retail transactions. In other instances, well-known instruction instances, protocols, structures and techniques have not been shown in detail in order not to obfuscate the description.

Introduction

Electronic funds transfer (EFT) is an electronic financial transaction that moves funds between accounts over a network(s). Examples of the financial transactions that can be conducted by EFT include debit transactions, wire transfers, online bill-pay services, etc. In addition to the originator of the funds transfer and the beneficiary, the parties involved may include the originator's financial institution, the beneficiary's financial institution and one or more intermediary financial institutions. With fund transfers across borders, the financial institutions may rely on their established business relationships with other institutions to complete the transaction. For example, the originator's and beneficiary's financial institution(s) may use an intermediary financial institution, such as a clearing house institution, as a go-between. Debit and credit instruction messages are passed between the financial institutions involved in the transfer of funds. Because beneficiary financial institutions may not have a relationship with originators, they do not perform originator identity authentication. Trust valuation is effected between institutions. If there is no established trust between institutions, an intermediary institution that the beneficiary's financial institution trust is used and the funds are transferred through the intermediary.

Overview

A transactional history based transaction risk assessment system can facilitate a more distributed electronic transaction paradigm encouraged by market and regulatory forces. The spread of banking and other commercial transactions to smartphones and the expanding Internet of things only increases the variety of transactions and channels for those transactions. This also increases the risk of transactions being used for fraud and money laundering under the current paradigm of a “1-degree of separation” trust evaluation (i.e., executing a transaction based on trust of the preceding financial institution without regard to the other entities involved in a transaction). For a comprehensive view of the parties involved in a transaction, a transaction risk assessment system can collect and persist digital credentials of entities' involved in a requested electronic transaction (i.e., credentials of the involved entities travel with the electronic transaction data). With the entity credentials, the transaction risk assessment system performs an on-demand risk analysis of the requested electronic transaction based, at least in part, on previously collected historical transaction data of the entities involved in the electronic transaction (hereinafter “transaction”). The risk assessment system searches the historical transaction data for information about the entities involved in the requested transaction and evaluates discovered information. The transaction risk assessment system can quantify trustworthiness of each entity involved in the requested transaction based on the evaluation of the discovered information. The transaction risk assessment system can then quantify risk of executing the transaction at least using the quantified trustworthiness of the involved entities.

Example Illustrations

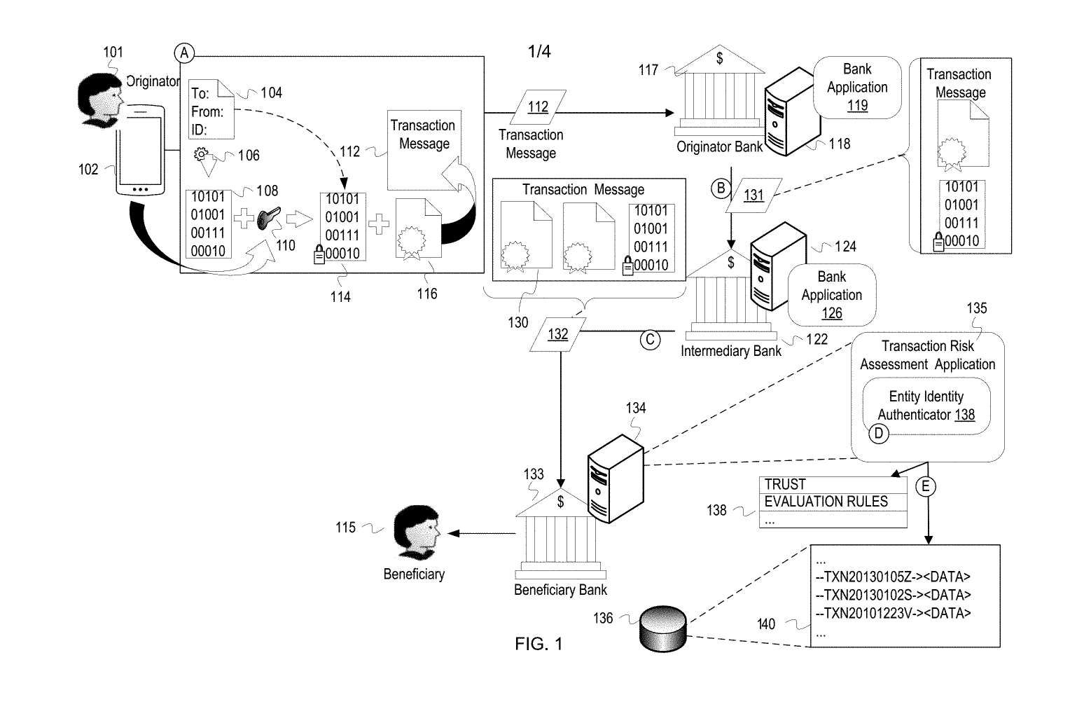

FIG. 1 depicts a conceptual example of a transactional history based transaction risk assessment system (hereinafter “risk assessment system”). The conceptual example illustrates the risk assessment system facilitating an electronic transaction between an originator 101 and a beneficiary 115. For this illustration, the transaction request involves server 118 of the originator's bank (“originator bank server”), server 124 of an intermediary bank (“intermediary bank server”), and server 134 of the beneficiary's bank (“beneficiary bank server”). The originator bank server 118 hosts a bank application 119. The intermediary bank server 124 hosts a bank application 126. The beneficiary bank server 134 hosts a transaction risk assessment application (hereinafter “risk assessment application”) 135. The risk assessment application 135 includes an entity identity authenticator 138.

FIG. 1 is annotated with a series of letters A-F. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, the originator 101 initiates an electronic fund transfer request 104 from his account in a bank 117 (“originator's bank”) to an account of the beneficiary 115 at a bank 133 (“beneficiary's bank”). The originator 101 initiates the electronic fund transfer request 104 using a client device 102. Examples of the client device 102 include a smart phone, a personal digital assistant, a tablet computer, etc. The electronic fund transfer request is effected with a transaction request instruction (hereinafter “transaction request”) 104. The transaction request 104 contains information such as the credit or debit instruction, originator's name, beneficiary's name, amount, originator's bank account number, beneficiary's bank number, and a transaction identifier.

Initiation of the electronic fund transfer request at stage A includes operations to communicate data for authenticating the originator 101 and guarantee the integrity of transaction request 104. Digitally signing the transaction request 104 provides assurance that the transaction request 104 is from the originator 101 and was not modified after signing. The process of digitally signing the transaction request 104 in this example illustration involves two steps. First, a cryptographic hash function 106 takes the transaction request 104 as input and produces a message digest 108. The second step involves encoding the message digest 108 with a private key 110 (bound to the device 102 and/or the originator 101) to generate a digital signature 114 for the transaction request 104. The device 102 then forms a transaction message 112 with the digital signature 114, the transaction request 104, and a digital certificate 116. In this illustration, the originator bank 117 issued the digital certificate 116 to the originator 101 and/or to the client device 102. The digital certificate 116 is part of a certificate chain with digital certificates of the originator bank 117 and a root CA. The client device 102 transmits the transaction message 112 to the originator bank 117 via a network(s). To ensure that transmission over the network is secure, several protocols may be used (e.g., transport layer security (TLS) or secure sockets layer (SSL)). Although FIG. 1 depicts the device 102 transmitting the transaction message 112, the message transmitted may actually be a modified version of the transaction message 112 after communication protocol stack processing, security processing, etc.

At stage B, the originator bank server 118 receives the transaction message 112 and the bank application 119 processes the transaction message 112 to validate the transaction message 112. Processing the transaction message 112 at least involves the bank application 119 authenticating the entities identified in the transaction message and validating the transaction request 104. The bank application 119 authenticates the originator of the transaction message with the transaction message 112. Authenticating the originator may involve authenticating each certificate in the certificate chain associated with the digital certificate 116. For example, the bank application 119 checks each certificate's status according to the online certificate status protocol (OCSP). The bank application 119 authenticates the originator 101 with the digital signature 114. The bank application 119 then verifies the authority of the originator 101 to submit the transaction request 104. The bank application parses the transaction request 104 to determine various information in the transaction request 104 such as the amount, originator name, etc. Authority verification may include determining certain conditions such as whether the originator 101 owns the account identified in the transaction request 104, whether the account has sufficient funds, etc. If the transaction message 112 is successfully validated, the originator bank 117 may add an indication of the validation to the transaction message 112 to yield a transaction message 131. The indication may be a seal, a token, a digital certificate, etc. In other embodiments, an entity may not add an indication of verification but imply validation by transmitting the transaction message. After processing the transaction message 112, the originator bank 117 instructs an intermediary bank 122 to effect the transaction request 104 by transmitting the transaction message 131 to the intermediary bank 122.

After receiving the transaction message 131, the bank application 126 of the intermediary bank 122 processes the transaction message 131 to validate the transaction message 131 and forward the transaction to the beneficiary bank 133 at stage C. Similar to stage B, the bank application 126 processing of the transaction message 131 at least includes authenticating the entities identified in the transaction message 131 and validating the transaction instructions from the originator bank 117. Since the intermediary bank 122 is not the endpoint of the requested transaction, the bank application 126 adds a digital certificate 130 to the transaction message 131 to form a transaction message 132. The digital certificate 130 can be used to authenticate the identity of the intermediary bank 122. In accordance with the transaction instructions, the bank application 126 communicates the transaction message 132 to the beneficiary bank 133. When adding the digital certificate 130 to the transaction message 131, the bank application 126 may update a “transaction entity list” that travels with the transaction message(s). The transaction entity list is a data structure, not necessarily a list, that indicates the entities involved in a transaction, thus identifying all parties that “touch” a transaction. The transaction entity list is not necessarily a predefined structure. The term generally refers to a data structure used to relate the identifying information used for authenticating the entities of the transaction. For instance, the transaction entity list may link digital certificates together in a list or table or be an array of offsets to digital certificates in a transaction message. The transaction entity list can vary dependent upon the type of identifying information within. In this example, the transaction entity list is comprised of certificates containing identifiable information of the originator 101, the originator bank 117, a root CA (an issuer of originator bank 117 certificate), and the intermediary bank 122 and any CA that issued a certificate to the intermediary bank. Examples of other identifying information that may be used to identify an entity include social security number, biometric information, and a tax identifier (e.g., employer identification number).

At stage D, the risk assessment application 135 assesses the risk of executing the transaction request 104 based on information in the received transaction message 132. Prior to assessing the risk, the entity identity authenticator 138 authenticates entities identified in the transaction entity list conveyed by the transaction message 132 in contrast to the conventional approach of authenticating the preceding entity, which in this case would be the intermediary bank 122.

After successful authentication of the entities identified in the transaction entity list, the risk assessment application 135 determines the risk of executing the transaction request 104 at stage E, based on historical transaction data 140. Representation of risk level can vary dependent upon any formalized specification of risk levels or an institution's preferred expression of risk level. Risk levels may be expressed with different descriptors corresponding to different levels (e.g., high risk, moderate risk or low risk) or quantified on a numeric scale. In determining the transaction risk, the risk assessment application 135 determines the trustworthiness of the entities in the transaction entity list. The trustworthiness of an entity may be represented by a trust value, which can be captured differently depending upon any formalized standard or institutional preference as with the risk levels. Determining the trustworthiness of each entity in the transaction entity list may be performed using various technique(s) (e.g., rule-based and/or machine-learning). In this illustration, the risk assessment application 135 loads trust evaluation rules and evaluates trust of each identified entity in the transaction entity list accordingly.

In applying rules to the historical transaction data 140 to assess an entity's trustworthiness, various mechanisms may be used. For example, a rating may be determined for each historical transaction relevant to the entities of the requested transaction 104. The determination may be based on factors such as the transaction amount, date, and outcome (i.e., whether the historical transaction was successfully executed or not). When multiple historical transactions indicate one of the involved entities, the risk assessment application 135 may aggregate ratings of each historical transaction, and then may aggregate those ratings per entity. For example, if an aggregation of the historical transaction ratings is positive, the entity may be determined to be trustworthy. A rule may be applied to disregard the overall transaction rating if certain trigger(s) occur. For example, an entity may be flagged as untrustworthy if there was at least one fraudulent transaction in the past.

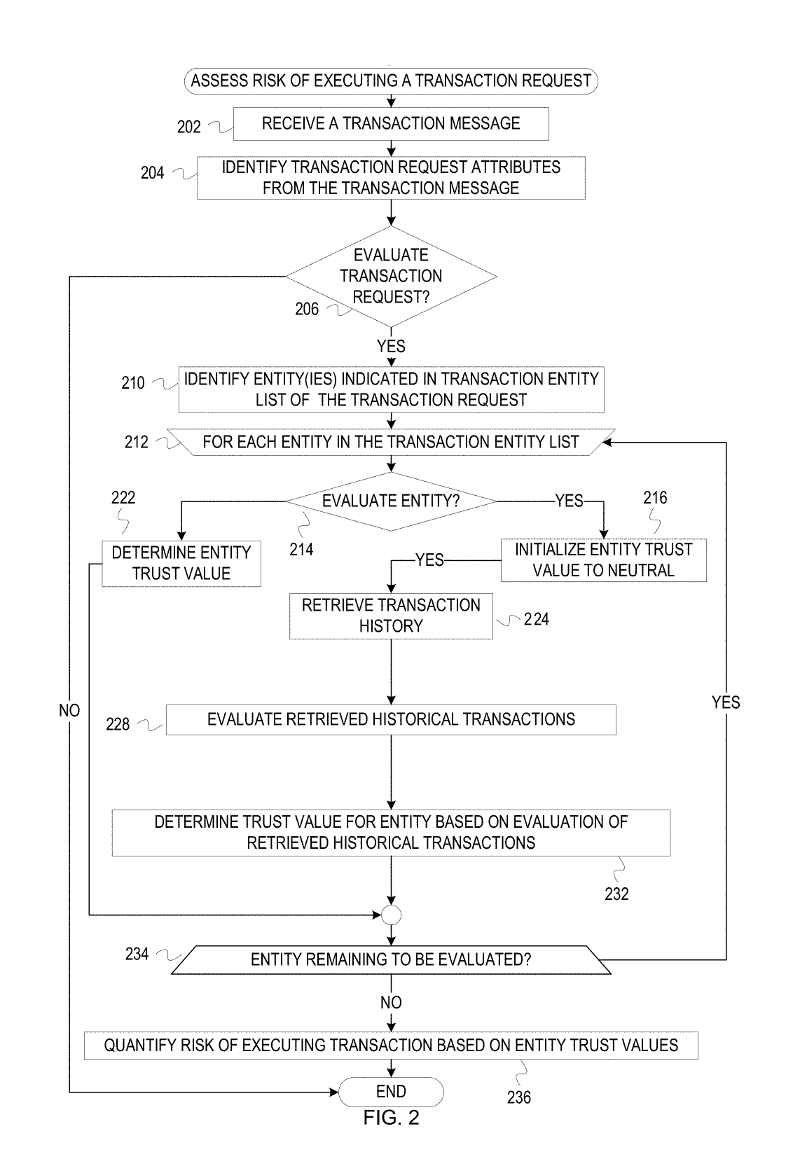

FIG. 2 depicts a flow diagram of example operations for assessing the risk of executing a transaction request. FIG. 2 refers to a risk assessment application performing the operations for naming consistency with FIG. 1 even though identification of program code can vary by developer, language, platform etc. These example operations assess the risk of executing a transaction request based on the trust values of entities identified for the transaction request.

A risk assessment application receives a transaction message (202). The transaction message may be a message communicated according to an Internet messaging protocol (e.g., hypertext transfer protocol (HTTP)). The risk assessment application and the bank application may be web based applications or services wherein data communication is achieved through various means, such as HTTP, simple object access protocol (SOAP), representational state transfer (REST) or application program interface (API). In another embodiment, the bank application updates a value (e.g., flag) that communicates to the risk assessment application that a transaction message was received. The risk assessment application then queries a data store to retrieve the transaction message. In addition, the risk assessment application may receive the transaction message as part of a batch of messages. The risk assessment application may receive transaction messages from a particular time period or of a particular type. For example, the risk assessment application may process transaction requests received the day before.

After receiving the transaction message, the risk assessment application identifies transaction request attributes (204). The attributes may be identified by parsing the transaction message according to a predefined schema for transaction messages. A transaction message schema may be defined by a standards body, commercial group, etc. The transaction message may employ tags that can be identified by the risk assessment application and parsed. For example, the risk assessment application can look for tags based on natural language processing or known identifiers (e.g., originator, account no, etc.). The transaction request attributes may include the transaction type, transaction amount, transaction date, originator name, timestamp, etc.

Based at least on the parsed attributes, the risk assessment application determines whether the transaction request is to be evaluated (206). Different criteria can be used by the risk assessment application to make this determination. The risk assessment application may make this determination based on the transaction amount. For example, if the transaction amount is below a certain threshold the risk of executing the transaction request will not be evaluated. The risk assessment application may also check a whitelist of entities. The whitelist may be a list of entities with an established reputation with the processing financial institution. With the persisted credentials, all involved entities indicated in the transaction entity list can be checked against the whitelist.

If the risk assessment application determines that the transaction request is to be evaluated, then the risk assessment application identifies the entity(ies) indicated in the transaction entity list associated with the transaction request (210). The risk assessment application may add an indication of the beneficiary into the transaction entity list. Identifying the entities may be no more than reading identifying information from the transaction entity list. However, the identifying information may not be the same as that used in transactional history data. The risk assessment application may normalize the identifying information or obtain other types of identifying information in case the historical transaction data is non-uniform or complies with more than one schema or standard for historical transaction data. For these cases, the risk assessment application obtains multiple identifying information for each entity, if available, and searches the historical transaction data with each different type of identifying information. For instance, the transaction entity list may indicate entities with certificate serial numbers. The risk assessment application may use the certificate serial numbers to obtain names of the entities, EINs for any business entities, etc. Then, for each entity, the risk assessment application can search over the historical transaction data with each identifying information. In some embodiments, each entity is identified by a unique identifier such as a globally unique identifier (GUID) that may be established and maintained by an industry organization or governmental body.

The risk assessment application begins to evaluate the identified entity(ies) in the transaction entity list (212). The risk assessment application can traverse the transaction entity list as structured, or rearrange the entity identifiers depending upon various factors. The rearrangement may be based on order of the identifying information, number of alternative identifying information found, etc. The description will refer to an entity being processed as the selected entity. And it should be understood that the “selected entity” is the selected entity identifier or identifying information. The risk assessment application evaluates each entity and quantifies trustworthiness of the entity based on past transactions in which the entity was an involved party. The risk assessment application can assign a factor or calculate a value that represents trustworthiness of the entity. Based on the quantified trustworthiness of the involved entities, the risk assessment application quantifies risk of executing the transaction.

The risk assessment application makes a determination of whether the selected entity is to be evaluated (214). A specific entity or an entity with a particular attribute (e.g., geographic location) may be assigned a trust value without evaluation (222). In some cases, an entity may be given a “pass” on evaluation and be assigned a pre-defined or static trust value. Alternative, an entity may be assigned a trust value that quantifies low trustworthiness or no trustworthiness. For example, if the entity is based in a country known for fraudulent transactions, the entity's trust value may be set to −100.00. Similar to determining transactions that can forgo risk assessment, the risk assessment application can determine whether to evaluate the selected entity based on a whitelist of entities or whitelist of trusted attributes.

If the entity is to be evaluated, then the risk assessment application initializes the entity's trust value to neutral (216). A trust value may be a numeric value that represents a degree of trust. For example, a zero trust value denotes a neutral trust. A trust value of 100.0 may represent a 100% positive trust. A trust value of −100.0 may represent a 100% negative trust or distrust. In other embodiments, the trust value may be binary wherein a value of 0 represents that the entity is not trusted and a value of 1 represents that the entity is trusted. In yet other embodiments, the trust value may not be numeric. For example, a value may be according to a defined symbol based scale such as: Highly Trusted, Trusted, Neutral and Not Trusted.

After initialization of the entity's trust value, the risk assessment application retrieves the entity's transaction history (224). For example, the entity's transaction history may be retrieved from a data store by performing a query based on the entity's identifier. In another embodiment, the entity's transaction history may be retrieved based on a particular time period. The time period may be determined based on the transaction's time stamp for example. If the risk assessment application has multiple identifiers for the entity, then the risk assessment application can search the transaction history for each of the different identifying information. In some cases, hashes of the identifiers may be used.

The risk assessment application evaluates the retrieved historical transaction data (228). The risk assessment application can evaluate each historical transaction individually and/or evaluate the historical transactions as a group. For a group type analysis, the risk assessment application can analyze the history of transactions for patterns that relate to fraud, money laundering, etc. As examples, the risk assessment application can analyze the transaction history to determine whether the entity has established a pattern of similar transaction amounts in a pattern of time windows, a pattern of transaction initiations from various countries, or alternating account numbers. The risk assessment application can also evaluate each individual historical transaction based on one or more criteria (e.g., did the historical transaction amount exceed a threshold, did the historical transaction transfer funds into a specified country, etc.). When evaluating individual historical transactions, the risk assessment application can maintain an array or list of values that indicate score or rating of the individual historical transaction to be a factor in the trust value for the entity.

Based on the evaluation of the historical transaction data for the selected entity, the risk assessment application determines a trust value for the selected entity (232). If the evaluation included evaluation of individual historical transactions, risk assessment application can aggregate the individual transaction ratings. Aggregation may be a summation of the individual transaction ratings. Aggregation can also be a proportional summation. For example, each transaction rating can be multiplied by a coefficient that represents significance within the context of the transaction history. Significant can be based on the amount of the particular historical transaction as a percentage of total amounts of the historical transactions, based on age of the historical transaction, based on total number of transactions, or based on a combination of factors. The risk assessment application can also aggregate according to other techniques (e.g., compute a median of transaction ratings) depending upon the rating technique used. If only comprehensive evaluation was performed, then the risk assessment application can assign a trust value based on that evaluation. For instance, the risk assessment application can assign a trust value of Neutral if no suspicious patterns were found but all of the transactions were more than a 5 years old.

If there is another entity remaining to be evaluated, the transaction risk assessment application proceeds with processing the next entity (234). Otherwise, the risk assessment application quantifies the risk of executing the transaction based on the entity trust values (236). This quantification can be a summation of the trust values that is then normalized (e.g., add trust values and divide by number of entities). The risk assessment application may also use weights based on role of the entities. To illustrate, greater weights may be assigned to the originator and beneficiary institution than the intermediary institution. The risk assessment application can then apply the weights to the trust values of the respective entities.

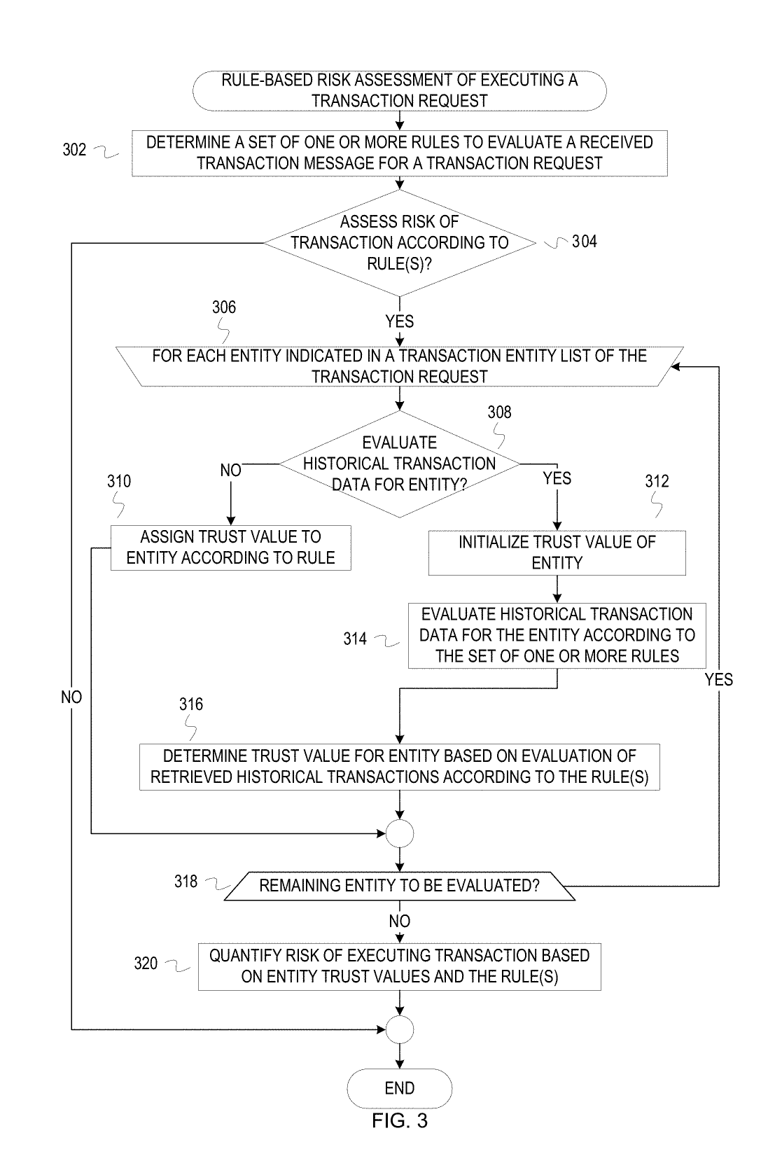

The operations depicted in FIG. 3 are generally similar to those depicted in FIG. 2. However, the operations depicted in FIG. 3 are adapted for implementations based on rule-based techniques. In rules-based analysis, rules are triggered by certain data. For example, the risk of executing the transaction may be determined by the type of the transaction request. Machine-learning techniques, such as statistical analysis may be used in conjunction with the rules. For example, statistical analysis may be used to estimate the risk in executing the transaction request based on the trend of similar transactions.

FIG. 3 depicts a flow diagram of example operations for assessing the risk of executing a transaction request using a rules-based technique. Similar to FIG. 2, FIG. 3 refers to the risk assessment application performing the operations for naming consistency with FIG. 1 even though identification of program code can vary by developer, language, platform etc. These example operations assess the risk of executing a transaction request based on the trust values of entities identified for the transaction request according to rules.

A risk assessment application determines a set of one or more rules to evaluate a received transaction message for a transaction request (302). Similar to FIG. 2, the transaction request is associated with a transaction entity list. The risk assessment application may determine the set of rules based on the transaction message and/or the transaction entity list. The risk assessment application may have a set of rules that is used regardless of the involved entities or attributes of the transaction. For example, the risk assessment application may use a set of rules defined by the financial institution hosting the risk assessment application.

The risk assessment application determines whether to assess risk of the transaction request according to the set of one or more rules (304). A rule may exempt transactions from risk assessment based on the entities involved in the transaction and/or attributes of the transaction. For instance, a rule may exempt transactions from risk assessment if the amount is below a threshold and all entities are within a same country. A rule may operate as a blacklist for risk assessment. For instance, a rule may specify that only transactions with a particular financial institution in the role as an intermediary will be risk assessed. If the transaction is exempt from risk assessment, then transaction request is passed along for execution.

If risk assessment is to be performed, then the risk assessment application begins to evaluate each entity indicated in a transaction entity list of the transaction request (306). As with FIG. 2, evaluating an entity may involve evaluating multiple identifiers for an entity. The description refers to an entity being evaluated as a “selected entity.”

Based on the rules, the risk assessment application determines whether the historical transaction data for the selected entity is to be evaluated (309). An institution may define a rule(s) that predefines a trust value as a default for a particular entity or an entity with a particular attribute (310). For example, a rule may specify a list of institutions to be assigned a high level of trust or a low level of trust. A rule may specify that an institution that does not occur in either a whitelist or a blacklist be assigned a trust value that is slightly below neutral (e.g., −10). After assigning the trust value, the risk assessment application proceeds to evaluate the next entity. If the risk assessment application is to evaluate the historical transaction data for the selected entity, then the risk assessment application initializes the trust value for the selected entity (312).

After initializing the trust value for the selected entity, the risk assessment application evaluates the historical transaction data for the selected entity according to the rule(s) (314). The risk assessment application searches or filters a repository of historical transactions for transactions that identify the selected entity. The risk assessment application can search for multiple identifiers that identify the selected entity. After determining historical transactions that identify the selected entity, the risk assessment application can evaluate the determined historical transactions according to the rule(s). Rules can specify data items to be considered in the evaluation and the type of evaluation. As mentioned in FIG. 2, the risk assessment application may perform a pattern analysis of the historical transaction data. Rules can specify that pattern analysis should be performed and a type of pattern analysis. Rules can also specify particular data items that influence the trust value for an entity. For instance, a rule may specify that transaction amounts and originator location impact trust value for the selected entity. Rules can also filter out historical transactions.

Based on the evaluation of historical transaction data, the risk assessment application determines a trust value for the selected entity based on the evaluation and according to the determined set of one or more rules (316). A rule can specify a formula for computing trust value for an entity. In addition, a rule can map a computed numeric value to a non-numeric quantification of trustworthiness (e.g., computed values above 80 map to highly trustworthy). If there is an additional entity to evaluate, then the risk assessment application continues on to the next entity (318).

With the entities' trust values, the risk assessment application quantifies risk of executing the transaction according to the rule(s) (320). Rules can specify different quantifications for different types of transactions or based on various transaction attributes. For example, transaction amounts above a threshold may trigger a rule that applies weights to increase the impact of trust values that represent trustworthiness below a particular trust score. This may be applied to increase scrutiny of large transactions. A financial institution or governmental body can define rules that increase risk value for a transaction with any attributes that are similar to attributes currently trending in fraudulent transactions.

Variations

The transaction entity list depicted earlier used certificates to identify the entities involved in the transaction. In other embodiments, the transaction entity list may be composed of at least one identifying information of the entity such as a biometric identifier and/or some other unique identifier such as a social security number or an EIN. In yet other embodiments, the transaction entity list may be composed of a certificate and/or a device unique identifier (e.g., CPU serial number, media access control (MAC) address) and/or an EIN. In other embodiments, a different data structure (e.g., block chain, ledger) may be used.

The above example illustrations refer to quantifying trustworthiness of an entity based on historical transaction data. An entity's trust value can also be based on non-historical transaction data. For instance, a risk assessment application can search for other pending transactions with a same originator when batch processing transactions. The risk assessment application may incorporate pending transactional data into the risk assessment. For instance, the risk assessment application may indicate greater risk or reduce an entity's trust value if the risk assessment application detects multiple pending transactions for an entity from different accounts in different countries.

Other factors such as the probability of occurrence may also be used. For example, if the fraudulent activity of the entity may have occurred 20 years ago, the probability factor maybe set to uncertain. On the other hand, if the fraudulent activity of the entity occurred in the current year, the probability factor may be set to certain. Other probability factors may include likely, possible, unlikely and rare. In other embodiments, numeric values may be assigned to the probability factors.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations for evaluating entities may be done in parallel. As another example, the risk assessment application may initialize a trust value (312) after the historical transaction data evaluation (314). It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

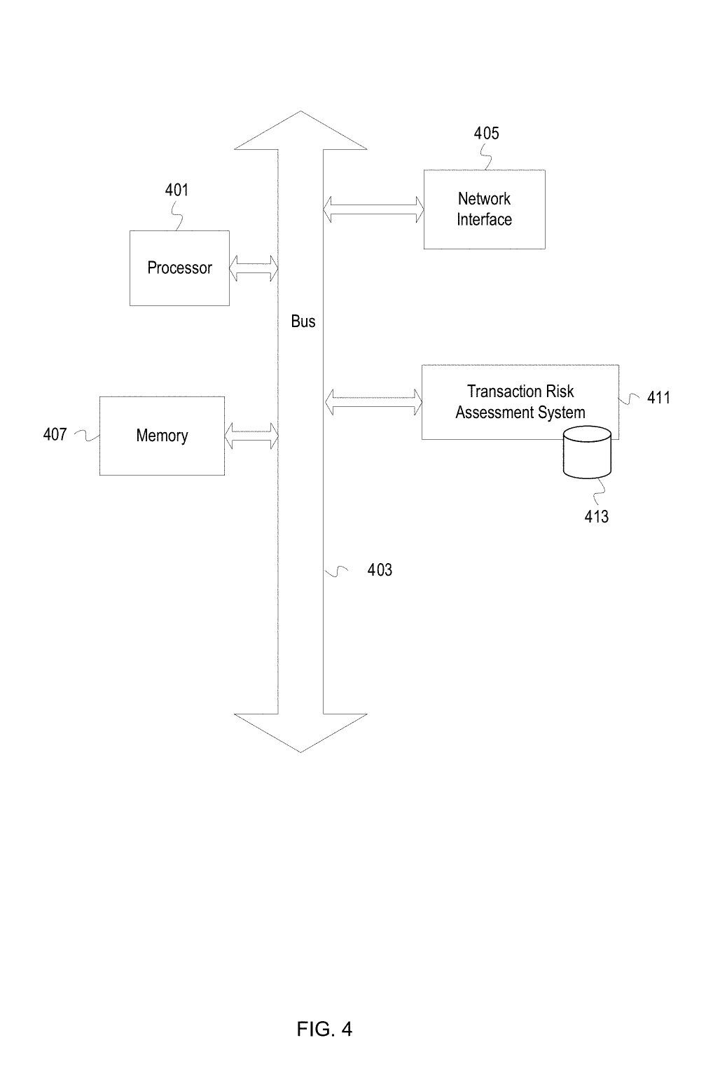

FIG. 4 depicts an example computer system with an electronic transaction risk assessment based on digital identifier trust evaluation system. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes an electronic transaction risk assessment system 411. The electronic transaction risk assessment system 411 accesses a historical transaction data store 413 that is depicted as part of the example computer system, but can also be remote. The risk assessment system 411 accesses the historical transaction data store 413 to evaluates historical transactions that indicate entities involved in a transaction being assessed for risk. The risk assessment system 411 uses the historical transaction data to formulate a trust value for the involved entities. The risk assessment 411 then determines a risk assessment or risk factor for the transaction being requested based on the trust values. Any one of the previously described functionalities may be partially (or entirely) implemented in hardware and/or on the processor unit 401. For example, the functionality may be implemented with an application specific integrated circuit, in logic implemented in the processor unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401 and the network interface 405 are coupled to the bus 403. Although illustrated as being coupled to the bus 403, the memory 407 may be coupled to the processor unit 401.

While the aspects of the disclosure are described with reference to various implementations and exploitations, it will be understood that these aspects are illustrative and that the scope of the claims is not limited to them. In general, techniques for electronic transaction risk assessment based on digital identifiers as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
for each of a plurality of entities identified as participating in a requested electronic transaction,
after successful authentication of the entity with identity information of the requested electronic transaction,
determining, from historical transaction data, one or more historical transactions that indicate the entity;
determining a trust value for the entity based, at least in part, on data for the historical transactions that indicate the entity;
assigning the trust value to the entity;
determining a risk value for the requested electronic transaction based, at least in part, on the trust values assigned to the plurality of entities; and
communicating the risk value for the requested electronic transaction for determination of whether to execute the requested electronic transaction.

2. The method of claim 1 further comprising determining a set of one or more rules, wherein determining the risk value is also based, at least in part, on the set of one or more rules.

3. The method of claim 2, wherein determining the set of one or more rules is based, at least in part, on an attribute of the requested electronic transaction.

4. The method of claim 2, wherein determining the trust value for each of the plurality of entities comprises:
evaluating one or more attributes of the one or more historical transactions against one or more criteria of the set of one or more rules,
wherein the trust value is based, at least in part, on the evaluation.

5. The method of claim 1 further comprising identifying the plurality of entities from identifying information in a data structure associated with the requested electronic transaction.

6. The method of claim 1 further comprising determining that the requested transaction request is not exempt from risk assessment based, at least in part, on an attribute of the requested electronic transaction.

7. The method of claim 1, wherein determining the risk value comprises aggregating the trust values of the plurality of entities.

8. The method of claim 1, wherein determining the risk value is also based, at least in part, on an attribute of the requested electronic transaction, wherein the attribute comprises at least one of number of the plurality of entities, location of a beneficiary account of the requested electronic transaction, location of an originator account of the requested electronic transaction, an amount of the requested electronic transaction, and a location of an intermediary institution facilitating the requested electronic transaction.

9. One or more non-transitory machine-readable media comprising program code for electronic transaction risk assessment, the program code to:
for each of a plurality of entities identified as participating in a requested electronic transaction,
after successful authentication of the entity with identity information of the requested electronic transaction,
determine, from historical transaction data, one or more historical transactions that indicate the entity;
determine a trust value for the entity based, at least in part, on data for the historical transactions that indicate the entity;
assign the trust value to the entity;
determine a risk value for the requested electronic transaction based, at least in part, on the trust values assigned to the plurality of entities; and
communicate the risk value for the requested electronic transaction for determination of whether to execute the requested electronic transaction.

10. The one or more non-transitory machine-readable media of claim 9 further comprising program code to determine a set of one or more rules, wherein determining the risk value is also based, at least in part, on the set of one or more rules.

11. The one or more non-transitory machine-readable media of claim 10, wherein the program code to determine the set of one or more rules comprises program code to determine the set of one or more rules based, at least in part, on an attribute of the requested electronic transaction.

12. The one or more non-transitory machine-readable media of claim 10, wherein the program code to determine the trust value for each of the plurality of entities comprises program code to:
evaluate one or more attributes of the one or more historical transactions against one or more criteria of the set of one or more rules,
wherein the trust value is based, at least in part, on the evaluation.

13. The one or more non-transitory machine-readable media of claim 9, wherein the program code further comprises program code to identify the plurality of entities from identifying information in a data structure associated with the requested electronic transaction.

14. The one or more non-transitory machine-readable media of claim 9, wherein the program code further comprises program code to determine that the requested transaction request is not exempt from risk assessment based, at least in part, on an attribute of the requested electronic transaction.

15. The one or more non-transitory machine-readable media of claim 9, wherein the program code to determine the risk value comprises program code to aggregate the trust values of the plurality of entities.

16. The one or more non-transitory machine-readable media of claim 9, wherein the program code to determine the risk value comprises program code to determine the risk value also based, at least in part, on an attribute of the requested electronic transaction, wherein the attribute comprises at least one of number of the plurality of entities, location of a beneficiary account of the requested electronic transaction, location of an originator account of the requested electronic transaction, an amount of the requested electronic transaction, and a location of an intermediary institution facilitating the requested electronic transaction.

17. An apparatus comprising:
a processor; and
a machine-readable medium having program code executable by the processor to cause the apparatus to,
for each of a plurality of entities identified as participating in a requested electronic transaction,
after successful authentication of the entity with identity information of the requested electronic transaction,
determine, from historical transaction data, one or more historical transactions that indicate the entity;
determine a trust value for the entity based, at least in part, on data for the historical transactions that indicate the entity;
assign the trust value to the entity;
determine a risk value for the requested electronic transaction based, at least in part, on the trust values assigned to the plurality of entities; and
communicate the risk value for the requested electronic transaction for determination of whether to execute the requested electronic transaction.

18. The apparatus of claim 17, wherein the machine-readable medium further comprises program code to determine a set of one or more rules, wherein determining the risk value is also based, at least in part, on the set of one or more rules.

19. The apparatus of claim 18, wherein the program code to determine the set of one or more rules comprises program code to determine the set of one or more rules based, at least in part, on an attribute of the requested electronic transaction.

20. The apparatus of claim 18, wherein the program code to determine the trust value for each of the plurality of entities comprises program code to:
evaluate one or more attributes of the one or more historical transactions against one or more criteria of the set of one or more rules,
wherein the trust value is based, at least in part, on the evaluation.
